(19) United States
(12) Patent Application Publication
(10) Pub. No.: US 2008/0250956 A1
(43) Pub. Date: Oct. 16, 2008

(54) MARKING SYSTEM

(75) Inventors: Ann McSweeney, Columbus, OH (US); Iwona B. Alter, San Diego, CA (US); Chak Por Lee, Hong Kong (CN); Kevin O. Doherty, Hong Kong (CN)

Correspondence Address: MCNEES WALLACE & NURICK LLC, 100 PINE STREET, P.O. BOX 1166, HARRISBURG, PA, 17108-1166, US

(73) Assignee: ELMER'S PRODUCTS, INC., Columbus, OH (US)

(21) Appl. No.: 11/734,985

(22) Filed: Apr. 13, 2007

(51) Int. Cl. B41K 1/38

(52) U.S. Cl. 101/327

(57) ABSTRACT

A marking system is provided that includes a marking device having a volume of marking fluid stored therein. The marking device further includes: a head assembly that includes: a housing having a base with at least one aperture passing therethough, a frame mounted within the housing, wherein the frame further includes at least one biasing member that acts against the housing to allow a portion of the frame to extend from the housing or to be compressed into the housing, and a flexible, porous applicator mounted within the frame; and a flexible reservoir that is adapted to be attached to the head assembly. The at least one aperture in the base provides fluid communication between the applicator and the volume of marking fluid.

### BACKGROUND OF THE INVENTION

The described invention relates in general to a system for creating marks on surfaces, and more specifically to a stamping device and for making creative, colorful marks on paper or other surfaces.

Marking devices that are used for the purpose of stamping unique, creative, or artistic patterns on various surfaces are not unknown in the prior art. However, many of these devices are simply rubber or plastic stamps that must be dipped in an external reservoir of paint, ink, or even wax before they can be used to create the desired mark. Such devices are often only partially effective in that they create sloppy, uneven, or inconsistent marks, and the use thereof may result in paint or ink being transferred to surfaces other that the intended surface. Furthermore, prior art stamping devices dry out quickly and many require re-inking before each use, making them less than convenient in most cases. Thus, there is an ongoing need for a cleaner, neater marking device that may be used to stamp unique patterns on surfaces in a consistent, reproducible, and satisfactory manner.

### SUMMARY OF THE INVENTION

The following provides a summary of exemplary embodiments of an inventive system for making colorful marks on surfaces. This summary is not an extensive overview and is not intended to identify key or critical aspects or elements of the present invention or to delineate its scope.

In accordance with one aspect of the present invention, a stamping/marking system is provided. This marking system includes: a marking device and a volume of marking fluid stored within the marking device. The marking device further includes: (a) a head assembly, wherein the head assembly further includes: (i) a housing, wherein the housing further includes a base, and wherein the base further includes at least one aperture passing therethough; (ii) a frame, wherein the frame is mounted within the housing, wherein the frame further includes at least one biasing member, and wherein the at least one biasing member acts against the housing to allow a portion of the frame to extend from the housing when the marking device is not in use and to allow the extended portion to be compressed into the housing when the marking device is in use; and (iii) a flexible, porous applicator, wherein the applicator is mounted within the frame, wherein a portion of the applicator extends beyond the front, i.e., forward, edge of the frame, and wherein a portion of the applicator extends into the housing and makes contact with the base; and (b) a flexible reservoir, wherein the reservoir is adapted to be attached to the head assembly. The volume of marking fluid is stored within the reservoir, and the at least one aperture in the base provides fluid communication between the applicator and the volume of marking fluid.

In accordance with another aspect of the present invention, a stamping/marking device is provided. This marking device includes: a head assembly and a flexible reservoir for holding marking fluid. The head assembly further includes: (a) a housing, wherein the housing further includes a cap and a base, and wherein the base further includes at least one channel passing therethough; (b) a frame, wherein the frame is mounted within the housing, wherein the frame further comprises at least one biasing member, and wherein the at least one biasing member acts against the base to allow a portion of the frame to extend from the housing through the cap when the marking device is not in use and to allow the extended portion to be compressed into the housing when the marking device is in use; and (c) a flexible, porous applicator in fluid communication with the at least one channel, wherein the applicator is mounted within the frame, wherein a portion of the applicator extends beyond the front, i.e., forward, edge of the frame, and wherein a portion of the applicator extends into the housing and makes contact with the base. The flexible reservoir is adapted to be attached to the head assembly, and the at least one channel in the base allows marking fluid in the reservoir to pass through the base and into the applicator.

In yet another aspect of this invention, a method for producing a stamped mark is provided. This method includes providing a marking device that includes: (a) a head assembly, wherein the head assembly further includes: (i) a housing, wherein the housing further includes a base, and wherein the base further includes at least one channel passing therethough; (ii) a frame, wherein the frame is mounted within the housing, wherein the frame further includes at least one biasing member, and wherein the at least one biasing member acts against the housing to allow a portion of the frame to extend from the housing when the marking device is not in use and to allow the extended portion to be compressed into the housing when the marking device is in use; and (iii) a flexible, porous applicator, wherein the applicator is mounted within the frame, wherein a portion of the applicator extends beyond the front, i.e., forward-most, edge of the frame, and wherein a portion of the applicator extends into the housing and makes contact with a portion thereof; and (b) a flexible reservoir, wherein the reservoir is adapted to be attached to the head assembly, and wherein the at least one channel in the base provides fluid communication between the reservoir and the applicator. A volume of marking fluid is stored within the reservoir. The method further includes applying pressure to the sides of the flexible reservoir, wherein applying such pressure causes the marking fluid to move from the reservoir, though the base, and into the applicator; and contacting the applicator to a surface and applying force sufficient to compress the frame into the housing, wherein compressing the frame into the housing also compresses the applicator and dispenses marking fluid onto the surface.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIGS. 1A-B are exploded and assembled perspective views, respectively, of a marking device in accordance with an exemplary embodiment of the present invention.

FIG. 2A is an assembled, side view of a marking device in accordance with an exemplary embodiment of the present invention.

FIG. 2B is a cross-sectional view of the marking device of FIG. 2A.

FIG. 3A is an assembled, side view of the head assembly of a marking device in accordance with an exemplary embodiment of the present invention.

FIG. 3B is a cross-sectional view of the head assembly of FIG. 3A.

FIGS. 4A-D are exploded, perspective views of certain components of a marking device in accordance with an exemplary embodiment of the present invention, illustrating alternate geometric configurations for these components.

FIG. 5A-D are top views of the frame component of a marking device in accordance with an exemplary embodiment of the present invention illustrating, alternate geometric configurations for this component.

FIG. 6 is a rear perspective view of the frame component of a marking device in accordance with an exemplary embodiment of the present invention showing the placement of the biasing legs on the bottom portion of the frame component.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a stamping or marking system and device having a marking head assembly and a reservoir integrated therewith. A first general embodiment of this invention provides a marking system which includes a marking device and a volume of marking fluid stored within the marking device. A second general embodiment of this invention provides a marking device which includes a head assembly and a flexible reservoir for holding marking fluid. A third general embodiment of this invention provides a method for producing a stamped mark which includes providing a marking device having an applicator and a flexible reservoir filled with colored paint or ink, compressing the reservoir to deliver the paint or ink to the applicator, and firmly contacting the applicator to a surface to create, i.e., stamp, a mark thereon. With reference now to the Figures, one or more specific embodiments of this invention shall be described in greater detail.

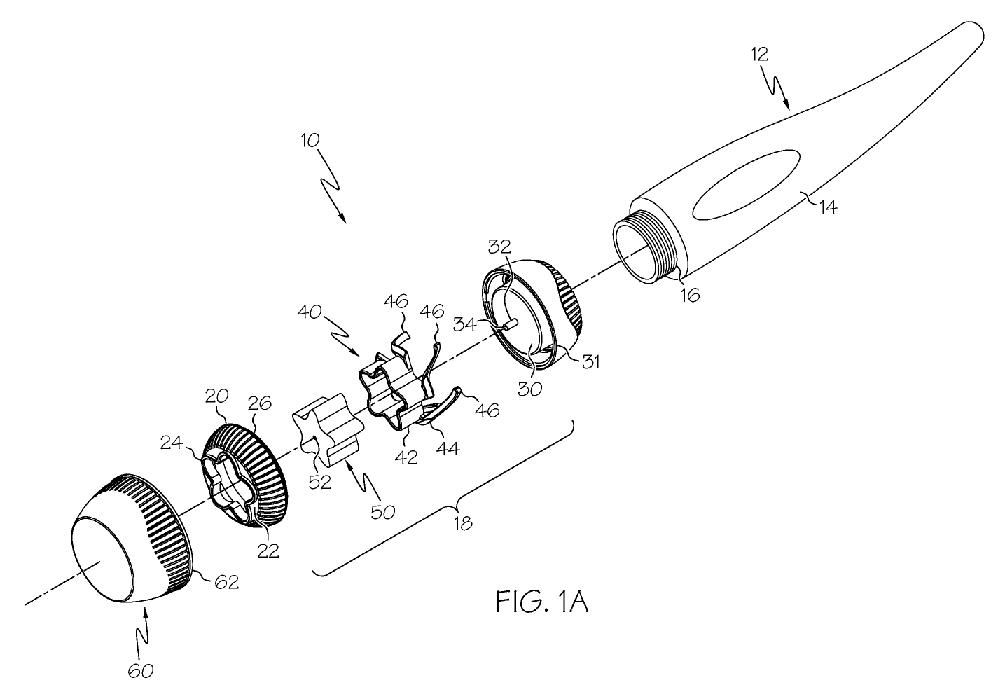

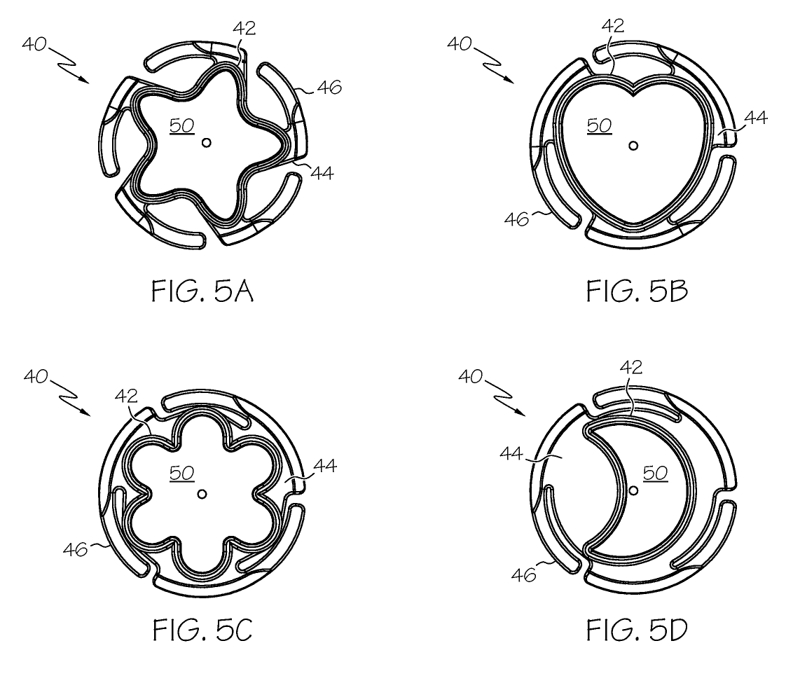

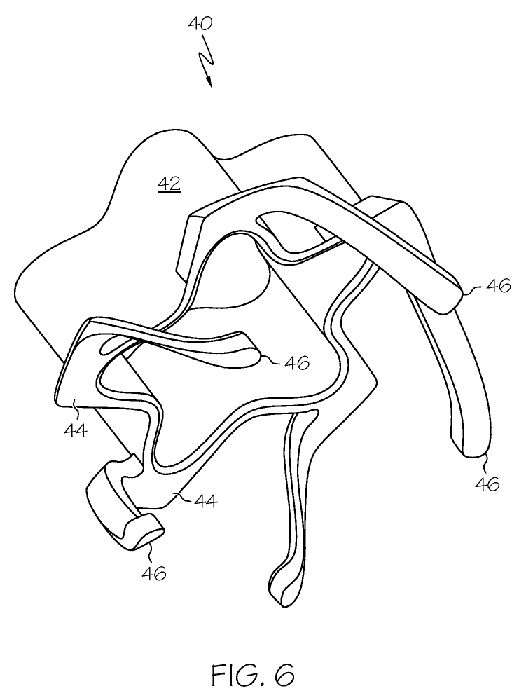

FIGS. 1-6 provide various illustrative views of certain exemplary embodiments of this invention. The exemplary embodiment of marking device 10 shown in FIGS. 1A-B, 2A-B, and 3A-B includes a generally cylindrical reservoir 12 and a head assembly 18, to which reservoir 12 is attached. Reservoir 12 is typically manufactured from a flexible material, such as a relatively thin molded plastic, and includes a narrowed, threaded neck 16, which is inserted into head assembly 18 when marking device 10 is fully assembled. The materials disclosed in U.S. Pat. No. 7,172,360, the entirety of which is incorporated by reference herein, are compatible with reservoir 12 of the present invention. As best shown in FIGS. 1A-B, reservoir 12 also includes an elongated body 14 that tapers to a point at one end. Various surface features, such as ridges, indentations, or textures may be included at various points along the length of body 14. Reservoir 12 may be clear, opaque, or may be any of a variety of different colors.

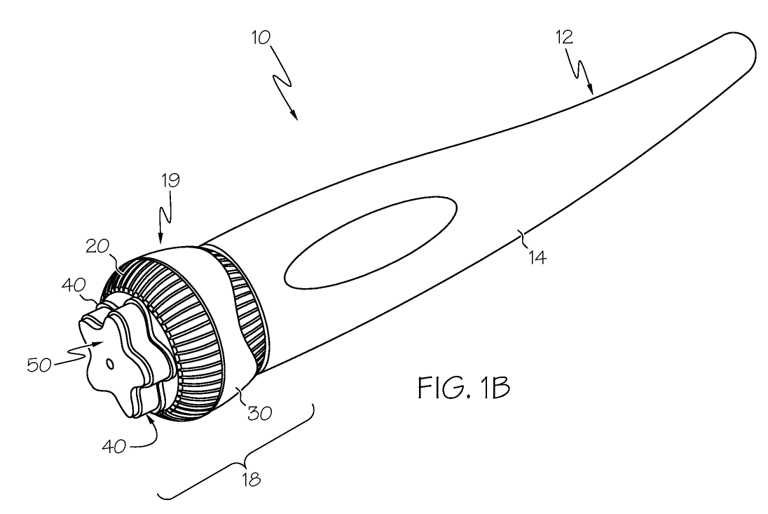

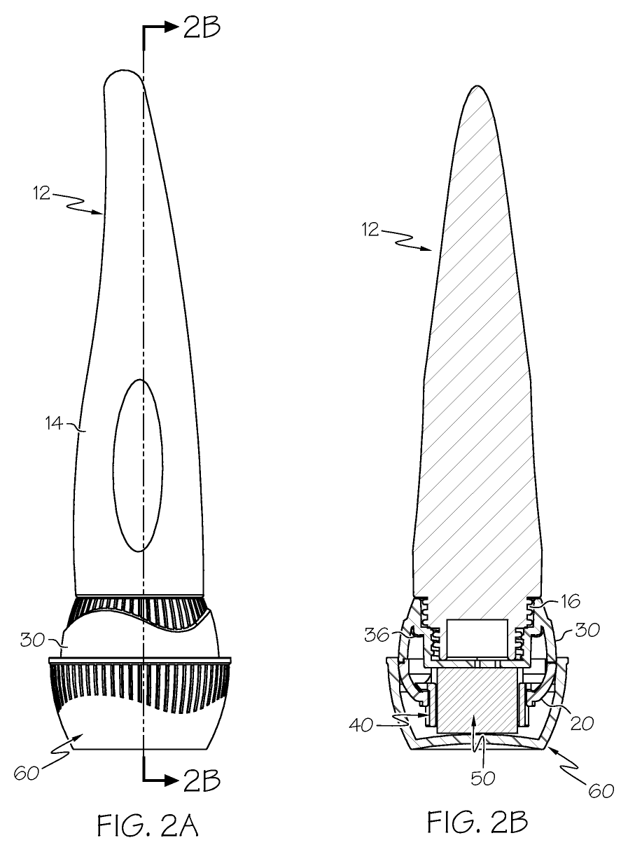

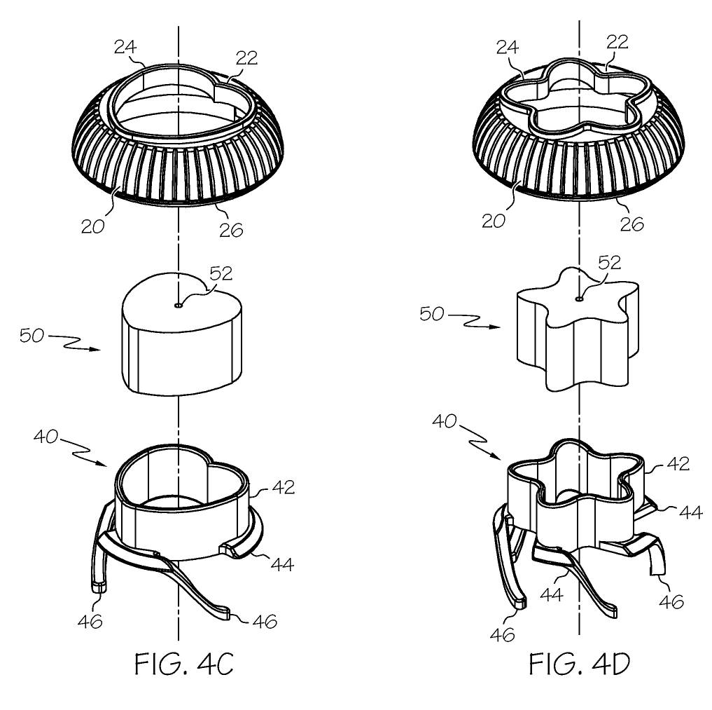

With reference to FIGS. 2A-B and 3A-B, head assembly 18 includes a housing 19, a flexible frame 40, which is mounted within housing 19, and an applicator 50, which is mounted within housing 19. Housing 19 is typically manufactured from rigid plastic and includes a first portion or top 20 and a bottom portion or base 30, which is attached to top 20, usually by adhesive, sonic welding, or other permanent or semi-permanent means. Top 20 is typically a domed-shaped structure that includes a rounded forward end or tip 22, within which an aperture 24 has been formed. In the exemplary embodiments, aperture 24 includes a unique geometric pattern or shape, such as, for example, a flower, a half-moon, a heart, a star (see FIGS. 4A-D) or a butterfly (not shown). Numerous other shapes are possible for use with or incorporation into the present invention. An attachment means such as an indention, collar or ridge 26 is formed at the opposite end of top 20 for engaging a corresponding attachment means, i.e., groove 31, on base 30, thereby allowing the two components 20 and 30 to be assembled to form housing 19. In the exemplary embodiment shown in FIG. 1A, the top portion of base 30 further includes at least one protrusion 32 through which an aperture 34 extends. The opposite or bottom side of base 30 includes a stepped recessed inner surface 36, a portion of which is adapted (e.g., tapped) to receive threaded neck 16, which is formed at one end of reservoir 12. A plastic cap 60 may be placed on housing 19 for storage purposes. A rear portion 62 of cap 60 engages housing 19 midway along the length thereof and snaps into place when light to moderate pressure is applied to cap 60.

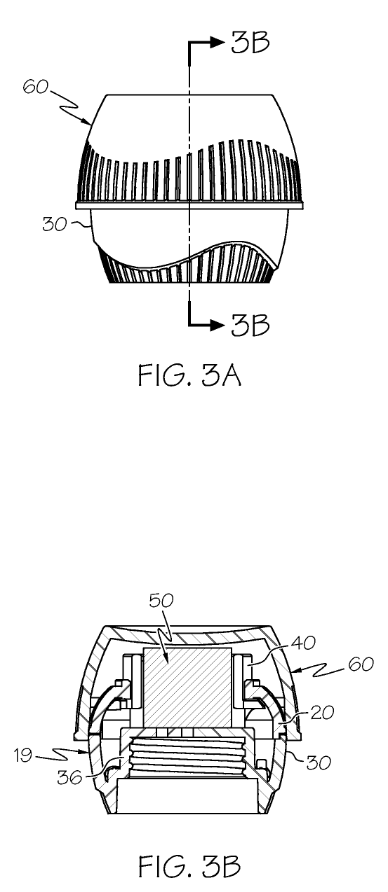

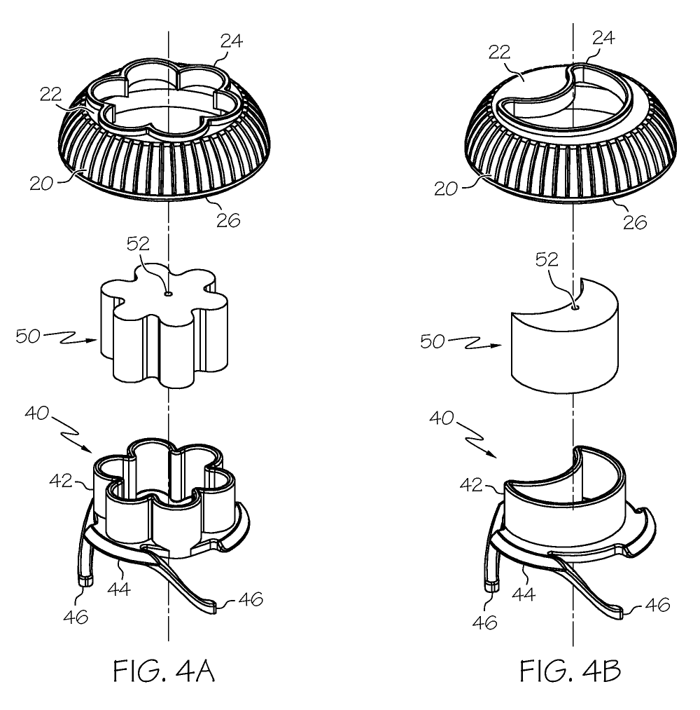

With reference to FIGS. 4A-D, 5A-D, and 6, frame 40 includes an upper portion 42, a lower portion 44, and a plurality of biasing members or legs 46, which extend downwardly from lower portion 44. Frame 40 is typically manufactured from semi-rigid plastic or other suitable material. Upper portion 42 forms a generally collar-like retaining member which includes a unique geometric shape or pattern that matches that of aperture 24 (formed in top 20 of housing 19). Lower portion 44 includes a partial planar ring-like structure attached to or formed integrally with the base of upper portion 42 and individual biasing members 46 extend downward and angle away from lower portion 44. As best shown in FIGS. 4A-D and 6, biasing members 46, which vary in number from embodiment to embodiment, are typically elongated, slightly curved, spring-like structures that provide resiliency to frame 40. When axial pressure is applied to the top portion of frame 40, biasing members 46 deform slightly and allow frame 40 to change its position, i.e., move inward as the force is applied. When the pressure is released, frame 40 quickly returns to its previous position. In other embodiments of this invention, biasing members 46 are replaced with a coiled spring or similar biasing devices. As shown in FIGS. 2B and 3B, when marking device 10 is fully assembled, the lower portion of frame 40 is enclosed within housing 19, and biasing members 46 contact the upper portion of base 30, which provides a rigid surface against which the biasing members may act. Additionally, the upper portion and top edge of frame 40 extend partially out of housing 19 through aperture 24.

With reference to FIGS. 1 and 4A-D, applicator 50, which includes at least one aperture 52, also includes a unique geometric shape or pattern that matches that of both frame 40 and aperture 24. Applicator 50 is typically a flexible (i.e., compressible), porous sponge or similar material that is capable of absorbing and retaining a volume of ink, paint, or other marking fluid. When marking device 10 is fully assembled, applicator 50 is inserted into frame 40 such that the bottom edge of applicator 50 contacts base 30 and the top edge of applicator 50 extends past the upper edge of frame 40 (e.g., about 5-20 mm or more). Applicator 50 may be glued or otherwise secured to base 30. Protrusion 32 on base 30 extends partially into aperture 52 in applicator 50. Aperture 34, which is formed in and passes through protrusion 32, provides a conduit from base 30 into reservoir 12, thereby permitting the flow of paint, ink, or other marking fluid between reservoir 12 and applicator 50. Additional apertures or conduits may be formed in and on base 30 for facilitating the flow of paint, ink, or other marking fluid between reservoir 12 and applicator 50.

When marking device 10 is in use, reservoir 12 is filled with ink, tempra/tempera paint, or any other suitable marking fluid. The user of marking device 10 squeezes the sides of reservoir 12 to force marking fluid to flow through aperture 34 and into applicator 50 where it is absorbed and held. When applicator 50 is covered with a volume of marking fluid, the user touches the exposed end of applicator 50 to a surface, applies even downward pressure, and then pulls marking device 10 away from the surface to reveal a colored, substantially two-dimensional shape. This stamping motion may be repeated several times to cover the entire surface of applicator 50 with enough marking fluid to create a mark having the desired geometric characteristics. Maintaining even pressure on the sides of reservoir 12 will continuously dispense marking fluid into and onto applicator 50 (until the marking fluid is depleted), thereby allowing numerous marks to be made in any given marking session. Thus, neither an external source of marking fluid, nor re-inking is necessary with the present invention. Additionally, each stamping motion typically causes applicator 50 to retract into frame 40 and with each release stroke as applicator 50 returns to its starting shape, excessive marking fluid is removed from the sides of applicator 50 to reduce sloppiness. When marking device 10 is not in use, cap 60 is placed over head assembly 18 to prevent the marking fluid in applicator 50 from drying out and to prevent unwanted dispensation of marking fluid on surfaces other than the surface intended for stamping.

In one embodiment of the present invention, marking device 10 is packaged in a kit for commercial sale. The contents of this kit may vary, but will typically include at least one temporarily sealed ink-filled reservoir 12 and two or more head assemblies 18, each of which includes a different applicator 50. The head assemblies 18 are interchangeable, i.e., different head assemblies can be used with the same reservoir by simply removing one head assembly and replacing it with another head assembly.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A marking system comprising:
(a) a marking device, wherein the marking further includes:
(i) a head assembly, wherein the head assembly further includes:
a) a housing, wherein the housing further includes a base, and wherein the base further includes at least one aperture passing therethough;
b) a frame, wherein the frame is mounted within the housing, wherein the frame further includes at least one biasing member, and wherein the at least one biasing member acts against the housing to allow a portion of the frame to extend from the housing when the marking device is not in use and to allow the extended portion to be compressed into the housing when the marking device is in use; and
c) a flexible, porous applicator, wherein the applicator is mounted within the frame, wherein a front portion of the applicator extends beyond the front edge of the frame, and wherein a rear portion of the applicator extends into the housing and makes contact with the base; and
(ii) a flexible reservoir, wherein the reservoir is adapted to be attached to the head assembly; and
(b) a volume of marking fluid, wherein the volume of marking fluid is stored within the reservoir, and wherein the at least one aperture in the base provides fluid communication between the applicator and the volume of marking fluid.

2. The marking system of claim 1, wherein the frame further includes at least one unique geometric shape and wherein the shape of the applicator substantially matches the unique geometric shape of the frame.

3. The marking system of claim 2, wherein the at least one unique geometric shape is selected from the group consisting of stars, hearts, flowers, half-moons, and butterflies.

4. The marking system of claim 1, wherein the at least one biasing member further includes at least one resilient leg formed integrally with the frame.

5. The marking system of claim 1, wherein the at least one biasing member further includes a spring disposed within the housing between the frame and the base.

6. The marking system of claim 1, wherein the applicator further includes a sponge.

7. The marking system of claim 1, wherein the marking fluid is selected from the group consisting of tempra paint and ink.

8. A marking device, comprising:
(a) a head assembly, wherein the head assembly further includes:
(i) a housing, wherein the housing further includes a cap and a base, and wherein the base further includes at least one channel passing therethough;
(ii) a frame, wherein the frame is mounted within the housing, wherein the frame further comprises at least one biasing member, and wherein the at least one biasing member acts against the base to allow a portion of the frame to extend from the housing through the cap when the marking device is not in use and to allow the extended portion to be compressed into the housing when the marking device is in use; and
(iii) an applicator in fluid communication with the at least one channel, wherein the applicator is mounted within the frame, wherein a front portion of the applicator extends beyond the front edge of the frame, and wherein a rear portion of the applicator extends into the housing and makes contact with the base; and
(b) a flexible reservoir for holding marking fluid, wherein the reservoir is adapted to be attached to the head assembly, and wherein the at least one channel in the base allows marking fluid in the reservoir to pass through the base and into the applicator.

9. The marking device of claim 8, further comprising a cap mountable on the housing portion of the head assembly.

10. The marking device of claim 8, wherein the frame further includes at least one unique geometric shape and wherein the shape of the applicator substantially matches the unique geometric shape of the frame.

11. The marking device of claim 10, wherein the at least one unique geometric shape is selected from the group consisting of stars, hearts, flowers, half-moons, and butterflies.

12. The marking device of claim 8, wherein the at least one biasing member further includes at least one resilient leg formed integrally with the frame.

13. The marking device of claim 8, wherein the at least one biasing member further includes a spring disposed within the housing between the frame and the base.

14. The marking system of claim 8, wherein the applicator further includes a sponge.

15. The marking system of claim 8, wherein the marking fluid is selected from the group consisting of tempra paint and ink.

16. A method for producing a mark, comprising:
(a) providing a marking device, wherein the marking further includes:
(i) a head assembly, wherein the head assembly further includes:
a) a housing, wherein the housing further includes a base, and wherein the base further includes at least one channel passing therethough;
b) a frame, wherein the frame is mounted within the housing, wherein the frame further includes at least one biasing member, and wherein the at least one biasing member acts against the housing to allow a portion of the frame to extend from the housing when the marking device is not in use and to allow the extended portion to be compressed into the housing when the marking device is in use; and
c) an applicator in fluid communication with the at least one channel, wherein the applicator is mounted within the frame, wherein a front portion of the applicator extends beyond the front edge of the frame, and wherein a rear portion of the applicator extends into the housing and makes contact with a portion thereof; and
(ii) a flexible reservoir, wherein the reservoir is adapted to be attached to the head assembly, and wherein the at least one channel in the base provides fluid communication between the reservoir and the applicator; and
(b) storing a volume of marking fluid within the reservoir;
(c) applying pressure to the sides of the flexible reservoir, wherein applying such pressure causes the marking fluid to move from the reservoir, though the base, and into the applicator; and
(d) contacting the applicator to a surface and applying force sufficient to compress the frame into the housing, wherein compressing the frame into the housing also compresses the applicator and dispenses marking fluid onto the surface.

17. The method of claim 16, wherein the frame further includes at least one unique geometric shape and wherein the shape of the applicator substantially matches the unique geometric shape of the frame.

18. The method of claim 17, wherein the at least one unique geometric shape is selected from the group consisting of stars, hearts, flowers, half-moons and butterflies.

19. The method of claim 16, wherein the at least one biasing member further includes at least one resilient leg formed integrally with the frame.

20. The method of claim 16, wherein the at least one biasing member further includes a spring disposed within the housing between the frame and the base.

21. The method of claim 16, wherein the applicator further includes a sponge.

22. A kit for making a mark on a surface, the kit comprising:
(a) at least one reservoir, wherein the at least one reservoir further includes a volume of marking fluid; and
(b) at least two head assemblies, each head assembly being attachable to the at least one reservoir, wherein each head assembly further includes:
(i) a housing, wherein the housing further includes a base, and wherein the base further includes at least one channel passing therethough;
(ii) a frame, wherein the frame is mounted within the housing, wherein the frame further includes at least one biasing member, and wherein the at least one biasing member acts against the housing to allow a portion of the frame to extend from the housing when the marking device is not in use and to allow the extended portion to be compressed into the housing when the marking device is in use; and
(iii) an applicator in fluid communication with the at least one channel, wherein the applicator is mounted within the frame, wherein a front portion of the applicator extends beyond the front edge of the frame, and wherein a rear portion of the applicator extends into the housing and makes contact with a portion thereof.

23. The kit of claim 22, further comprising a cap mountable on the housing portion of each head assembly.

24. The kit of claim 22, wherein the frame further includes at least one unique geometric shape and wherein the shape of the applicator substantially matches the unique geometric shape of the frame.

25. The kit of claim 24, wherein the at least one unique geometric shape is selected from the group consisting of stars, hearts, flowers, half-moons, and butterflies.

26. The kit of claim 22, wherein the at least one biasing member further includes at least one resilient leg formed integrally with the frame.

27. The kit of claim 22, wherein the at least one biasing member further includes a spring disposed within the housing between the frame and the base.

28. The kit of claim 22, wherein the applicator further includes a sponge.

29. The kit of claim 22, wherein the marking fluid is selected from the group consisting of tempra paint and ink.
